(19) United States
(12) Patent Application Publication
(10) Pub. No.: US 2006/0143569 A1
(43) Pub. Date: Jun. 29, 2006

(54) Communication using avatars

(76) Inventors: Michael Patrick Kinsella, Glasgow (GB); John Law McGuire, Glasgow (GB)

Correspondence Address: FLESHNER & KIM, LLP, P.O. BOX 221200, CHANTILLY, VA, 20153, US

(21) Appl. No.: 10/526,746

(22) PCT Filed: Sep. 8, 2003
(86) PCT No.: PCT/GB03/03854

§ 371 Date: Dec. 6, 2005

(30) Foreign Application Priority Data
Sep. 6, 2002 (GB) 0220748.8

(51) Int. Cl. G06F 17/00

(52) U.S. Cl. 715/752

(57) ABSTRACT

A messaging method is described in which avatars, representative of attributes of users and individuals, are used for capturing information and/or selecting users or individuals. In one embodiment, an avatar is rendered in response to attributes input by a user, and a matching and retrieval selects records from a database. Avatars are rendered in accordance with the attributes in the records. The user selects an avatar, and is able to communicate anonymously with the individual. Methods and systems for capturing data using avatars and selecting individuals using avatars are also described.

This invention relates to the general fields of capturing attribute data of individuals and selecting individuals using captured data, and more specifically to the use of avatars for capturing attribute data and selecting individuals. Aspects of the invention relate to messaging systems and methods utilising avatars to facilitate rich but anonymous interaction.

In the field of messaging, text is commonly used to identify users of messaging systems in ways that describe their physical, geographical or social attributes. This allows others to select users for the receipt of messages. Such text offers descriptive information but maintains anonymity and privacy. A series of static graphical icons can also convey this information. However, the problem with this approach is that it does not present users with a simple, instant visual description that assists in making a go/no-go decision on whether or not to pursue contact.

If a user wants to show other users what they look like, they can post a photograph. However, a high percentage of Internet dating site users do not and will not post photographs of themselves for reasons of personal privacy; they would inevitably lose some anonymity.

Posting some other static image depicting some of their physical attributes is an option, for example using a drawing program or scan of a hand drawing. However, this is often not convenient for the user and it does not facilitate automated searching for or organising of the attributes, other than by some complex pattern-recognition software trawling through the images.

The user is therefore constrained in that they can either keep anonymity but not convey their appearance adequately, or lose anonymity by showing what they look like with a photograph. Furthermore, a problem with static images, including photographs, is that they are not easy to update with real time information about the user.

At present, Microsoft®'s instant messaging service depicts its Buddy List as a set of monochrome pawns with names below. This pawn representation does provide anonymity if accompanied by a user name that is pseudonymous, and thus would hide the identity of the associated user. However, the viewer still has to rely on the text to identify users, due to the uniformity of the pawn representations.

Items on the Buddy List also provide status information, for example indicating that another user is on-line, but fail to convey more detailed information about the user. For example, characteristics such as the users appearance, location, or present activity are not conveyed. Worse still, the rendering of the Buddies on the list is performed without reference to the current status of the attributes of the user being represented. Even if the text is descriptive of such attributes, it is rendered using information that was entered at the time of registration of the users' account.

It is an object of the present invention to provide convenient capture of individual's attributes.

It is a further object of the present invention to provide convenient selection of an individual from their attributes.

It is a further object of the present invention to provide convenient use of individual's attributes for messaging.

According to a first aspect of the invention, there is provided a method of messaging comprising the steps of:
maintaining a database of records, each record comprising attributes of an individual and an identifier of said individual;
receiving at least one input attribute from a user;
retrieving at least one record from the database in accordance with at least one input attribute;
identifying an individual corresponding to each selected record;
rendering at least one avatar using attributes comprised in the at least one selected record;
selecting a rendered avatar;
sending a message to the identified individual.

According to a second aspect of the invention, there is provided a method of messaging comprising the steps of:
maintaining a database of records, each record comprising attributes of an individual and an identifier of said individual;
receiving at least one input attribute from a user;
rendering an avatar responsive to the input attributes;
retrieving at least one record from the database in accordance with at least one input attribute;
identifying an individual corresponding to each retrieved record;
sending a message to the identified individual.

The method may comprise the additional step of rendering at least one avatar using attributes comprised in the selected records.

The method may comprise the additional step of selecting at least one of the rendered avatars.

Preferably, the step of selecting at least one of the rendered avatars is in response to a selection input by the user.

The method may comprise the additional step of receiving the message from the user.

The method may comprise the additional step of verifying that a status of a user is such that the user is not blocked from sending a message to an identified individual.

The method may comprise the additional step of determining whether a user has been assigned a status of disallowed sender to an identified individual, and preventing the rendering of an avatar corresponding to that identified individual.

Preferably, the step of determining a status of the user is dependent on the identity of the user and the identity of the individual.

The status of the individual may be determined using the database.

The method may comprise the steps of storing an identifier associated with a selected record, and determining the status of the individual using the associated identifier.

The method may comprise attributes relating to a location of an individual.

According to a third aspect of the invention, there is provided a system for messaging comprising:
a storage means for storing a plurality of records, each record comprising attributes of an individual and an identifier of said individual;
an avatar rendering and selection means for rendering an avatar using attributes stored in the storage means, and selecting a rendered avatar; and

a messaging means, for identifying an individual corresponding to the selected rendered avatar, and sending a message to the identified individual.

The system may comprise a display for displaying a rendered avatar to the user.

Preferably, the avatar rendering and selection means is adapted to receive attributes input by a user for matching and retrieving data in the storage means and render an avatar responsive to said input attributes.

Preferably, the avatar rendering and selection means is adapted to match input attributes with records in the database and retrieve matched records.

Optionally, the input attributes relate to the location of an individual.

Optionally, the input attributes include details of an individual's physical appearance.

The details of the individual's physical appearance may be selected from a list of head shapes, eye colours, eyelid states, mouth types, hairstyles, hair colours, skin colours, breast size, belly size and clothing.

The clothing may be selected from a list comprising: top style, top colour, bottom style, bottom colour, shoe type and shoe colour.

The attributes of an individual may include details of the individual's behaviour.

The details of the individual's behaviour may be selected from a list comprising: smoking preference, drink preference, musical preference, and interests.

The avatar rendering and selection means may be further adapted to verify that a status of a user is such that the user is not blocked from sending a message to an identified Individual.

The avatar rendering and selection means may be further adapted to determine whether a user has been assigned a status of disallowed sender to an identified individual, and prevent the rendering of an avatar corresponding to that identified individual.

The avatar rendering and selection means may be further adapted to determine the status of the individual using the database.

The avatar rendering and selection means may be adapted to store an identifier associated with a selected record, and the status of the individual may be determined using the associated identifier.

Preferably, the inputting of attributes is performed using a graphical user interface that includes an output rendered avatar.

According to a fourth aspect of the invention, there is provided a method of capturing attributes of individuals comprising the steps of:
maintaining a database of records, each record comprising attributes of an individual and an identifier of an individual;
receiving at least one input attribute from a user;
rendering an avatar, responsive to said input attributes.

According to a fifth aspect of the invention, there is provided a system for capturing attributes of individuals comprising:
a storage means for storing a plurality of records, each record comprising attributes of an individual and an identifier of said individual;
a character engine means for receiving input attributes of an individual and rendering an avatar, responsive to said input attributes.

According to a sixth aspect of the invention, there is provided a method of selecting individuals comprising the steps of:
maintaining a database of records, each record comprising attributes of an individual and an identifier of said individual;
receiving at least one input attribute from a user;
retrieving at least one record from the database in accordance with at least one input attribute;
rendering at least one avatar using attributes comprised in the at least one selected record;
selecting a rendered avatar.

According to a seventh aspect of the invention, there is provided a system of selecting individuals comprising:
a storage means for storing a plurality of records, each record comprising attributes of an individual and an identifier of said individual;
an avatar rendering and selection means for rendering an avatar using attributes stored in the storage means, and selecting a rendered avatar.

In order to provide a better understanding of the present invention, various embodiments will now be described, by way of example only, and with reference to the accompanying Figures in which:

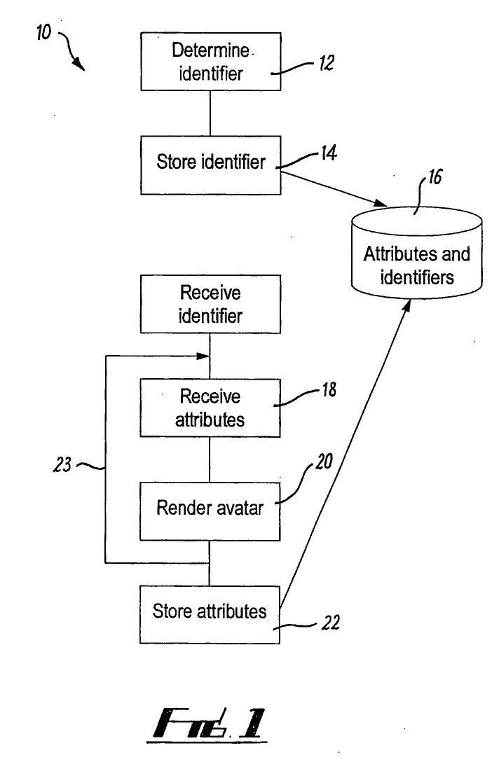

FIG. 1 illustrates a flow chart of the steps of a method of capturing attributes including rendering an avatar, in accordance with an embodiment of the invention;

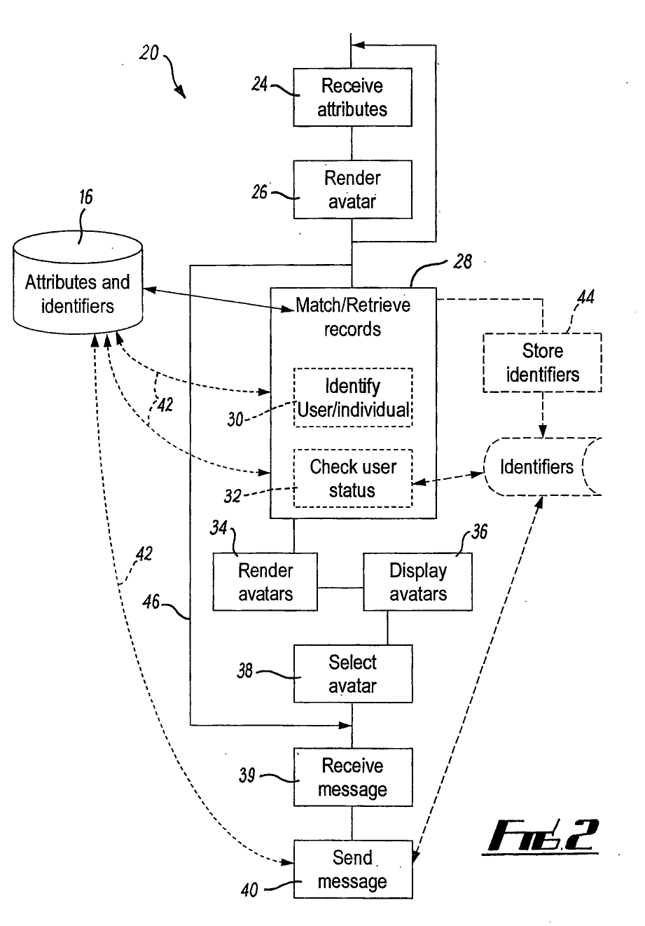

FIG. 2 illustrates a flow chart of the steps of a messaging method including the steps of selecting individuals using selection of avatars, in accordance with an embodiment of the present invention;

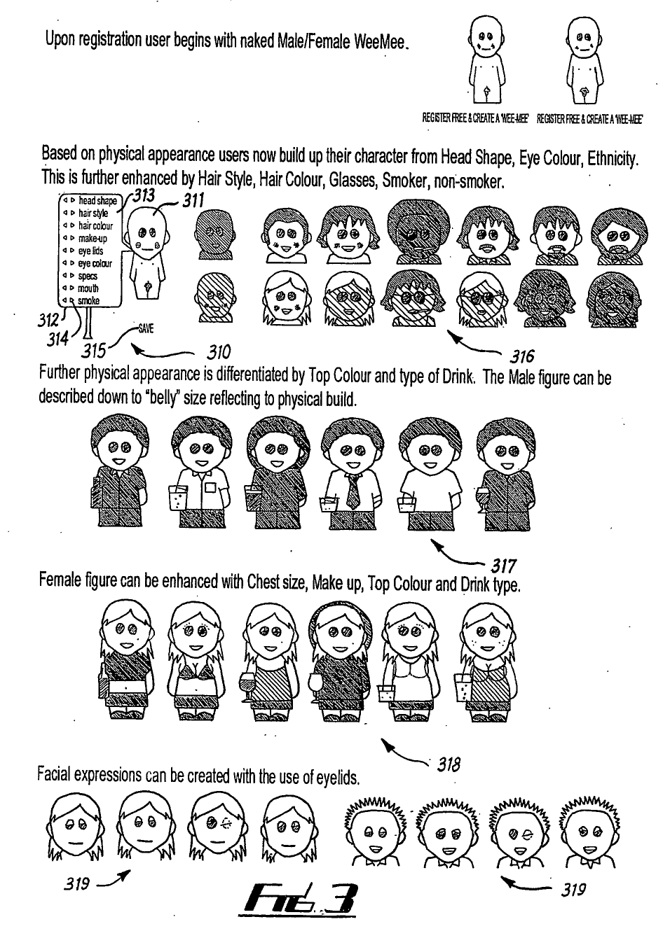

FIG. 3 illustrates a graphical user interface for building an avatar and a selection of avatars rendered to display a range of attributes in accordance with an embodiment of the invention; and

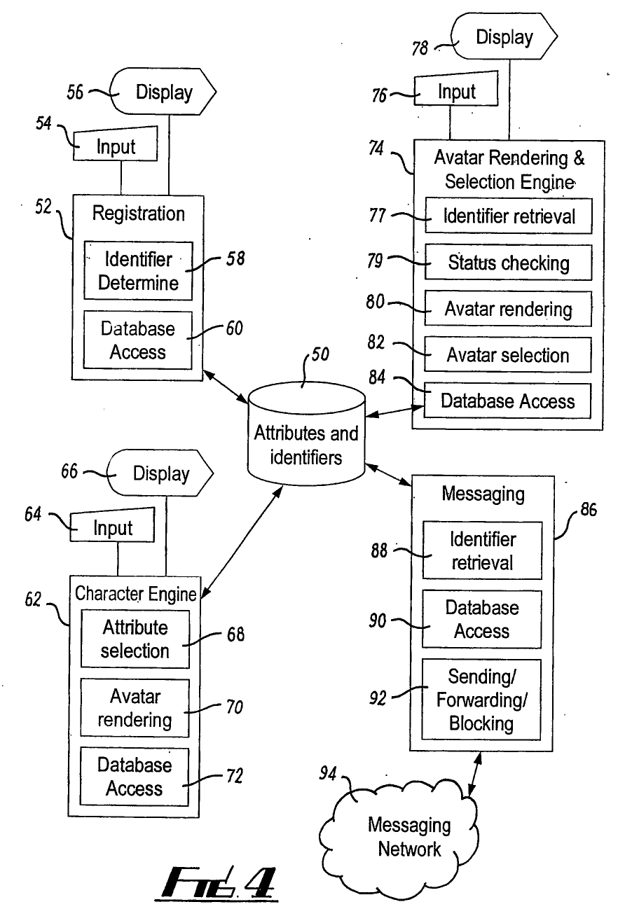

FIG. 4 illustrates the components of a system in accordance with an embodiment of the present invention;

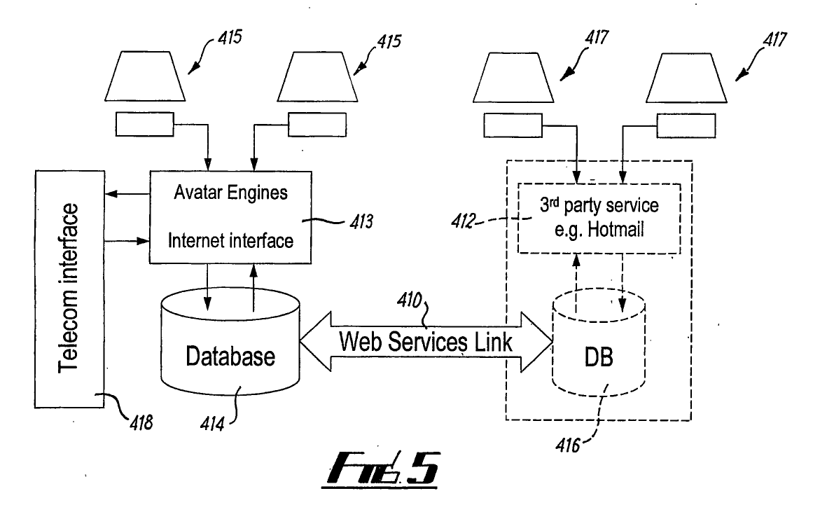

FIG. 5 illustrates a web services model used with an embodiment of the invention.

The invention is a method and system that functions to capture attributes of individuals through a convenient interface for both the maintenance of a database and selection of records in the database for messaging purposes.

With reference to FIG. 1, a flowchart 10 of an example method of capturing and using attributes of individuals is shown.

During registration, the system determines 12 the identifier of the individual, e.g. an email address, name, or pseudonym, and stores 14 the identifier in the database 16. The database 16 is maintained to contain attributes and identifiers of individuals.

The user inputs 18 attributes of an individual using a “character engine” graphical user interface that includes a displayed avatar. During registration, the attributes are personal attributes relating to the user itself, although they could also relate to another individual. The displayed avatar is rendered 20 responsive to the input attributes. The input attributes are stored 22 in the database 16 along with the identifier. The data including the attributes and the identifier can be termed a record.

This process allows users to describe themselves by building the avatar. In this embodiment, instead of using a series of drop down menus or text inputs, users build up the image of an avatar by graphically choosing hairstyle, hair colour, face shape, etc.

With reference to FIG. 3, upon registration, a graphical user interface 310 displays a naked avatar 311 with a menu 312 for selecting attributes 313. Attribute selection button 314 can be clicked on by the user to change the selected attribute, which also triggers the avatar-rendering module to re-render and output the avatar with the selected attribute depicted. A save button 315 can be clicked by the user to trigger the character engine to store the attribute in the database. Based on the physical appearance users now build up their avatar.

A selection of such avatar heads 316 is shown. Further physical appearance is differentiated by selecting the colour of clothing and preferred type of drink. Male FIGS. 317 can be described down to belly size reflecting physical build. Female avatars 318 can be enhanced with chest size, makeup, clothing colour and preferred drink. Facial expressions 319 can be created by the use of eyelids.

Attributes of an individual include details of the individual's physical appearance such as their head shape, eye colour, eyelid state, mouth type, hairstyle, hair colour, skin colour, breast size, belly size and their clothing.

Their clothing is selected from top style, top colour, bottom trousers, bottom colour, shoe type, and shoe colour.

The attributes may include details of the individual's behaviour such as smoking preference, drink preference, musical preference, interests and clothing preferences. Attributes may also include details of an individual's favourite community such as a sporting or musical community.

The attributes are stored in the database, starting with a “naked” avatar defined by the following data:
char_head_shape=oval
char_eye_col=blue
char_eye_lid=open
char_mouth=mouth6
char_hair_style=s15
char_hair_col=ginger
char_fag=no
char_specs=none
char_facial=none
char_makeup=lash
char_sex=female
char_col=black
char_chest=medium
char_belly=none
char_top=tshirt
char_top_col=white
char_bot=skirt1
char_bot_col=blue
char_shoe=shoes
char_shoe_col=white
char_drink=cock

This data represents a blank avatar that is displayed at the start of the registration process, or when a user visits the site and is not logged in. Note that although some of the values are actually set at this point, they need not be rendered on the avatar. For example ‘char_hair_col=ginger’ does not appear as ginger hair on the character because ‘char_hair_style=s15’ is given, which corresponds to the avatar having no hair.

After inputting or changing the attributes, the final attributes are stored in the database, for example:
char_head_shape=round
char_eye_col=brown
char_eye_lid=open
char_mouth=mouth1
char_hair_style=s13
char_hair_col=black
char_fag=no
char_specs=none
char_facial-none
char_makeup=lash
char_sex=female
char_col=white
char_chest=none
char_belly=none
char_top=sweat
char_top_col=yellow
char_bot=bare
char_bot_col=blue
char_shoe=bare
char_shoe_col=blue
char_drink=none

The user has thus created a personal avatar, and is able to download either the rendered avatar or the attributes themselves to their computer or mobile telephone for a variety of purposes. These purposes include personalised screen savers, telephone screen logos, email signatures or instant messaging personalities.

The “character engine” graphical user can be presented via web pages, I-mode, WAP, GPRS, MMS or SMS technologies and protocols using conventional programming techniques. In this embodiment, a Macromedia® Flash front end is used with an asp.net connection module to the database and a Microsoft® SQL Server database engine.

In certain embodiments, the avatar may be animated (e.g. rendered using an animated GIF) or may perform a number of automated tasks such as speech or making sound. The avatar or database may co-operate with software agents that perform other automated tasks. The avatars may be 3D representations, to which a user may associate a variety of animated routines and movements.

The avatars or stored attributes can be migrated to personalise web pages or for use in computer games. In addition, they may be used in the automated production of merchandise such as stationery (e.g. business cards), clothing, mouse mats, toys or other goods using the attributes to select various components of the toys or other goods. The stored identifier can be used for addressing delivery of the produced merchandise, etc.

At a later time, users may update 23, add to or amend their associated attributes, resulting in the rendering of an updated avatar and storing of an updated record. Any associated software modules, such as e-mail programs can remotely access the latest avatar to provide an updated graphical e-mail signature.

Users may also create avatars representative of friends or contacts, which can be used in directories, contact lists or as caller ids.

An aspect of the invention relates to a messaging method, including a method of selecting individuals, and is shown in FIG. 2 of the drawings, generally depicted at 20.

Messaging between users is performed by the maintenance of a database 16 of attributes and identifiers of individuals, as described above. In the preferred embodiment, the records in the database are entered in the manner described with reference to FIGS. 1 and 3.

A user inputs 24 attributes relating to an individual with which he may wish to communicate. These input attributes are used to render 26 an avatar, which is representative of an individual with which the user may wish to communicate. The attributes are entered by means of a “character engine” graphical user interface as described above with reference to FIGS. 1 and 3. The input attributes may be desired physical or social characteristics, or may relate to a geographical location of an individual to be communicated with, or a combination of all three.

The input attributes used for selecting records from the database may be attributes relating to the location of the user himself. For example, if the user inputs his geographical location, such as the name of a social venue or bar, via his mobile phone, the system subsequently selects and retrieves records 28 from the database that match only that location.

Subsequently, records from the database providing a match with the input attributes are selected and retrieved 28 from the database, and avatars are rendered 30 according to the stored attributes. The rendered avatars are displayed 36 on the user's display.

There may be one avatar rendered, or many, depending on the manner in which the records are selected from the database 16 by a matching and retrieval process. The selection process involves a trawl through the database records, and those records having the most attributes matching the input attributes are selected and avatars are rendered. Typically, the eight best-matched avatars are rendered, in order of suitability.

The embodiment of FIG. 2 includes an optional status checking step 32. An individual with a record stored on the database is able to assign a status to other users, from a set of possible statuses. These possible statuses include recipient, disallowed sender, and allowed sender. “Recipient” status is for users previously communicated with, or users with which the individual would wish to communicate. “Disallowed sender” is a status assigned to users from which the individual does not wish to receive messages. “Allowed sender” is the default status for users that may send messages to an individual. The statuses are user-specific, in that a status is assigned to a particular user (an assignee) by a particular individual (the assignor), and does not effect the assignees ability to communicate with individuals other than the assignor.

The status checking step 32 verifies the status assigned to the user by the individuals corresponding to the selected records. If any of the individuals have assigned a disallowed sender status to the user, an avatar will not be rendered responsive to their attributes, and thus will not be presented to the user for selection in subsequent steps. The user and the individuals, and their statuses, could be identified from the database, as shown by the dotted lines. Identity and status information may be accessed from a database (not shown) other than the database 16.

It should be noted that the identification of the user and the individuals, and their statuses could be carried out after the matching and retrieval process, or the matching process itself could ensure that the identification and status requirements are met before retrieval of the records.

The user then makes a selection 38 of the rendered avatars by clicking on the rendered avatar or an associated graphical display. The user enters a message which is forwarded to the individual who corresponds to the identifier of the selected avatar. The identity address of the individual may be obtained from the database 16, or another database (not shown), as depicted by the arrows 42.

As an alternative to the arrows 42 accessing identifier information from the database, all relevant identifiers, including status information can be retrieved during the retrieval 28 of the records. The identifiers can be stored 44, for example, as a link or embedded identifiers associated with the record or the rendered avatar.

The above-described method allows anonymous messaging between users, whilst allowing a user to select a recipient from a number of possible recipients based on a visual impression obtained from the graphically created avatars and other selection criteria.

The above description relates to a messaging method, although it will be appreciated that steps of the method could be used simply as a convenient method of selecting one or more individuals by:

maintaining a database 16 of attributes and identifiers of individuals;

retrieving 28 records from the database using input attributes;

rendering 34 and displaying 36 an avatar using attributes stored in the selected records; and

selecting 38 a rendered avatar.

It will also be apparent that although the above described messaging method renders avatars at two distinct steps (the input stage and the user selection stage), there may embodiments in which avatars are rendered at only one of the steps.

For example, a user may have pre-input a series of desired attributes, for which an avatar was rendered and stored. At a later time, for example when the user is present in a geographical location such as a bar or club, the user inputs the name of that location. The system conducts a search based on the pre-input attributes and the updated location, to provide a selection of avatars to the user that correspond to individuals that have indicated that they are present at that location. The user has thus obtained a short list of possible recipients that are in his immediate vicinity.

Alternatively, the messaging method may only render an avatar at the step of capturing the attributes, with the subsequent selection of the recipient being automated 46 by the system based on the input attributes and stored records.

An alternative use of the system is in providing an individual with a list of users whose desired attributes match his own personal avatar. In this example, previously stored attributes desired by an individual are used to carry out the matching and retrieval process described above. One or more individuals corresponding to records retrieved by the search are notified that they have been located, and an avatar corresponding to the user carrying out the search is displayed. The individual is then able to communicate with the user.

With reference to FIG. 4, an example system for capturing attributes of individuals, selecting individuals, and messaging is shown.

The system includes a database 50 of records, including attributes and identifiers of individuals implemented in Microsoft® SQL Server. A registration module 52 with its input 54 and display 56 is also provided. The registration module 52 also includes a module 58 for determining the identifier of the individual, and a module 60 implemented in asp.net for storing the identifier in the database 50.

The system further comprises a character engine 62 for inputting attributes, implemented using Macromedia® Flash with an input 64 and a display 66. The character engine also includes a selection module 68 for inputting or selecting attributes of an individual, and a rendering module 70 for rendering an avatar, in response to the input/selected attributes.

The character engine has a database access module 72 that stores the input attributes in the database 50.

The character engine 62 may be used to input attributes for selecting data from the storage means.

The system for messaging accesses the storage means 50 for storing the attributes and identifiers of individuals. The system includes an avatar rendering and selection engine 74 with an input 76, a display 78, and a module 80 for rendering an avatar using attributes stored in the storage means. The system also includes a module 82 for selecting a rendered avatar, and a database access module 84. The avatar rendering and selection engine 74 also includes identifier retrieval and status checking modules 77, 79 respectively, for determining whether or not a user has been specified as a blocked sender by the identified individuals.

The system includes a messaging engine 86 with an optional module 88 for identifying a recipient, allowed sender, or disallowed sender corresponding to the selected rendered avatar, and a module 92 for sending to, forwarding from, or blocking from the identified recipient or allowed sender or disallowed sender.

The messages are routed via a messaging network 94.

FIG. 5 shows a possible implementation in which the methods and systems of the present invention could be incorporated.

With reference to FIG. 5, the Web services link 410 allows third-party services 412 to access and retrieve locally created avatars and/or attributes from the database 414 which are created and maintained by systems 413 and methods in accordance with the present invention by users at terminals 415. The third party can access and retrieve based on a unique identifier such as e-mail address or phone number. This allows the third party to incorporate the personalised avatar and/or attributes into their service or database 416 for the benefit of their users on terminals 417. For example, this service could be a messaging service such as Hotmail®, MSN Instant Messenger®, or an ISP wishing to personalise their pages.

Via a Web Service is just one possible method of providing the avatars. The avatars may also be provided through agreement & database sharing, for example through a telecom interface 418.

Although the embodiments of the invention described with reference to the drawings comprise computer apparatus and processes performed in computer apparatus, the invention also extends to computer programs, particularly computer programs on or in a carrier, adapted for putting the invention into practice.

The program may be in the form of source code, object code, a code of intermediate source and object code such as a code in partially compiled form suitable for use in the implementation of the processes according to the invention.

The carrier may be any entity or device capable of carrying the program. For example, the carrier may comprise a storage medium such as ROM, for example a CD-ROM or a semiconductor ROM, or a magnetic recording medium, for example, a floppy disc or hard disc. Furthermore, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

Further modifications and improvements may be added without departing from the scope of the invention herein described.

1. A method of messaging comprising the steps of:
maintaining a database of records, each record comprising attributes of an individual and an identifier of said individual;
receiving at least one input attribute from a user;
retrieving at least one record from the database in accordance with at least one input attribute;
identifying an individual corresponding to each selected record;
rendering at least one avatar using attributes comprised in the at least one selected record;
selecting a rendered avatar; and
sending a message to the identified individual.

2. A method as claimed in claim 1 comprising the additional step of rendering an avatar in response to the input attributes.

3. A method of messaging comprising the steps of:
maintaining a database of records, each record comprising attributes of an individual and an identifier of said individual;
receiving at least one input attribute from a user; —rendering an avatar responsive to the input attributes; —retrieving at least one record from the database in accordance with at least one input attribute; and
identifying an individual corresponding to each retrieved record; —sending a message to the identified individual.

4. The method as claimed in claim 3 comprising the additional step of rendering at least one avatar using attributes comprised in the selected records.

5. The method as claimed in claim 4 comprising the additional step of selecting at least one of the rendered avatars.

6. The method as claimed in claim 1, wherein the step of selecting at least one of the rendered avatars is in response to a selection input by the user.

7. The method as claimed in claim 1, comprising the additional step of receiving the message from the user.

8. The method as claimed in claim 1, comprising the additiona! step of verifying that a status of a user is such that the user is not blocked from sending a message to an identified individual.

9. The method as claimed in claim 1, comprising the additional step of determining whether a user has been assigned a status of disallowed sender to an identified individual, and preventing the rendering of an avatar corresponding to that identified individual.

10. The method as claimed in claim 8, wherein the step of determining a status of the user is dependent on the identity of the user and the identity of the individual.

11. The method as claimed in claim 9, wherein the status of the individual is determined using the database.

12. The method as claimed in claim 9, comprising the steps of storing an identifier associated with a selected record, and determining the status of the individual using the associated identifier.

13. The method as claimed in claim 1, wherein the input attributes comprise attributes relating to a location of an individual.

14. A system for messaging comprising:
a storage means for storing a plurality of records, each record comprising attributes of an individual and an identifier of said individual;
an avatar rendering and selection means for rendering an avatar using attributes stored in the storage means, and selecting a rendered avatar; and
a messaging means, for identifying an individual corresponding to the selected rendered avatar, and sending a message to the identified individual.

15. The system as claimed in claim 14 further comprising a display for displaying a rendered avatar to the user.

16. The system as claimed in claim 14, wherein the avatar rendering and selection means is adapted to receive attributes input by a user for matching and retrieving data in the storage means and render an avatar responsive to said input attributes.

17. The system as claimed in claim 14, wherein the avatar rendering and selection means is adapted to match input attributes with records in the database and retrieve matched records.

18. The system as claimed in claim 14, wherein the input attributes relate to the location of an individual.

19. The system as claimed in claim 14, wherein the input attributes include details of an individual's physical appearance.

20. The system as claimed in claim 19 wherein the details of the individual's physical appearance are selected from a list of head shapes, eye colours, eyelid states, mouth types, hairstyles, hair colours, skin colours, breast size, belly size and clothing.

21. The system as claimed in claim 20 wherein the clothing is selected from a list comprising: top style, top colour, bottom style, bottom colour, shoe type and shoe colour.

22. The system as claimed in claim 14, wherein the attributes of an individual include details of the individual's behaviour.

23. The system as claimed in claim 22 wherein the details of the individual's behaviour are selected from a list comprising: smoking preference, drink preference, musical preference, and interests.

24. The system as claimed in claim 14, wherein the avatar rendering and selection means is further adapted to verify that a status of a user is such that the user is not blocked from sending a message to an identified individual.

25. The system as claimed in claim 14, wherein the avatar rendering and selection means is further adapted to determine whether a user has been assigned a status of disallowed sender to an identified individual, and prevent the rendering of an avatar corresponding to that identified individual.

26. The system as claimed in claim 14, wherein the avatar rendering and selection means is further adapted to determine the status of the individual using the database.

27. The system as claimed in claim 14, wherein the avatar rendering and selection means is adapted to store an identifier associated with a selected record, and the status of the individual is determined using the associated identifier.

28. The system as claimed in claim 14, further comprising a graphical user interface that includes an output rendered avatar which is configured to input attributes to the storage means.

29. A method of capturing attributes of individuals comprising the steps of:
maintaining a database of records, each record comprising attributes of an individual and an identifier of an individual;
receiving at least one input attribute from a user; and
rendering an avatar, responsive to said input attributes.

30. The method as claimed in claim 29, further comprising the step of storing the input attributes in the database.

31. The method as claimed in claim 29, further comprising the steps of determining an identifier of the individual and storing the identifier in the database.

32. A system for capturing attributes of individuals comprising:
a storage means for storing a database of a plurality of records, each record comprising attributes of an individual and an identifier of said individual; and
a character engine means for receiving input attributes of an individual and rendering an avatar, responsive to said input attributes.

33. The system as claimed in claim 32 wherein the character engine means is adapted to store the input attributes in the database.

34. The system as claimed in claim 32, further comprising a registration means for determining an identifier of the individual and storing the identifier in the database.

35. A method of selecting individuals comprising the steps of:
maintaining a database of records, each record comprising attributes of an individual and an identifier of said individual;
receiving at least one input attribute from a user;
retrieving at least one record from the database in accordance with at least one input attribute;
rendering at least one avatar using attributes comprised in the at least one selected record; and
selecting a rendered avatar.

36. The method as claimed in claim 35 comprising the additional step of rendering an avatar in response to the input attributes.

37. The method as claimed in claim 35, wherein the input attributes relate to the location of a user.

38. A system of selecting individuals comprising:
a storage means for storing a plurality of records, each record comprising attributes of an individual and an identifier of said individual; and
an avatar rendering and selection means for rendering an avatar using attributes stored in the storage means, and selecting a rendered avatar.

39. The system as claimed in claim 38 further comprising a character engine means for inputting attributes of an individual and rendering an avatar responsive to said attributes is adapted to input attributes for selecting data in the storage means.

40. The system as claimed in claim 38, wherein the input attributes relate to the location of an individual.

41. The system as claimed in claim 38, wherein the input attributes include details of an individual's physical appearance.

42. The system as claimed in claim 41 wherein the details of the individual's physical appearance are selected from a list of head shapes, eye colours, eyelid states, mouth types, hairstyles, hair colours, skin colours, breast size, belly size and clothing.

43. The system as claimed in claim 42 wherein the clothing is selected from a list comprising: top style, top colour, bottom style, bottom colour, shoe type and shoe colour.

44. The system as claimed in claim 38, wherein the attributes of in individual include details of the individual's behaviour.

45. The system as claimed in claim 44 wherein the details of the individual's behaviour are selected from a list comprising: smoking preference, drink preference, musical preference, and interests.

46. The system as claimed in claim 38, further comprising using a graphical user interface that includes an output rendered avatar which is configured to input attributes into the storage means.
